(19) United States
(12) Patent Application Publication
(10) Pub. No.: US 2023/0244268 A1
(43) Pub. Date: Aug. 3, 2023

(54) MOVABLE CONTROL PANEL ASSEMBLIES

(71) Applicant: Hewlett-Packard Development Company, L.P., Spring, TX (US)

(72) Inventor: David Bert Larson, Boise, ID (US)

(73) Assignee: Hewlett-Packard Development Company, L.P., Spring, TX (US)

(21) Appl. No.: 17/589,476

(22) Filed: Jan. 31, 2022

(51) Int. Cl. H04N 1/00

(52) U.S. Cl. CPC H04N 1/00496; H04N 1/00557; H04N 1/00559

(57) ABSTRACT

According to examples, a control panel assembly may include a base plate, a rib extending above the base plate, and a control panel support device to be positioned in sliding arrangement with the base plate. The control panel support device may include a groove having a first section and a second section, the first section having a first width and the second section having second width. The second width may be smaller than the first width. In addition, the rib may be inserted in the groove when the control panel support device is positioned in sliding arrangement with the base plate, in which the rib is to engage the second section of the groove when the control panel support device is extended away from the base plate, and in which the engagement between the rib and the second section of the groove is to reduce rotational movement between the control panel support device and the base plate.

### BACKGROUND

Printing devices, such as laser printers, laser multi-function printing devices, etc., typically use a printer cartridge that contains a recording material such as toner to record an image on a medium such as paper. Many printing devices include control panels through which users may receive information and input instructions for the printing devices. The control panels often include displays, such as touch-screen displays, through which users may view data and input the instructions.

### BRIEF DESCRIPTION OF DRAWINGS

Features of the present disclosure are illustrated by way of example and not limited in the following figure(s), in which like numerals indicate like elements, in which:

FIG. 1 shows a block diagram of an example control panel assembly including features to reduce rotational movement of a control panel support device;

FIG. 2A depicts an enlarged cross-sectional perspective view of a portion of the control panel assembly depicted in FIG. 1 corresponding to a first section of a groove in a control panel support device;

FIG. 2B depicts an enlarged cross-sectional perspective view of a portion of the control panel assembly depicted in FIG. 1 corresponding to a second section of the groove in the control panel support device; and

FIGS. 3A and 3B respectively show portions of an example printing device, partially in cross-section, in which the example printing device may include the control panel assembly depicted in FIG. 1.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Many types of printing devices, such as desktop or other types of relatively compact printing devices, may include control panel assemblies that may be movable between a stowed position and an extended position. The control panel assemblies may be movable to, for instance, reduce the size, e.g., footprints, of the printing devices. The sizes of the printing devices may be reduced to make shipping and/or movement of the printing devices simpler and more efficient. Once the printing devices are shipped to users, the users may unpack the printing devices from their shipping packages and may place the printing devices at their desired locations. In addition, the users may move the control panel assemblies from the stowed position to the extended positions. Users may fully access the control panels of the control panel assemblies when the control panel assemblies are in the extended positions. The control panels may provide, for instance, a graphical interface through which users may be provided with graphical information. The control panels may also provide the graphical interface to enable the users to interact with the printing devices, for instance, through touch input.

In many instances, however, the mechanisms through which the control panel assemblies slidably engage hardware inside of the printing devices may not adequately support the control panel assemblies. As a result, the control panel assemblies may move in directions perpendicular to the directions in which the control panel assemblies are slid in and out of the printing devices. This may result in the printing devices having a reduced quality look and feel.

Disclosed herein are control panel assemblies that may be movable between stowed positions and extended positions. Also discussed herein are printing devices, such as multifunction printing devices, that include the control panel assemblies. Particularly, disclosed herein are control panel systems that may provide support to reduce or prevent lateral and/or rotational movement of the control panel assemblies with respect to the chassis of the printing devices. For instance, the control panel assemblies disclosed herein may reduce or prevent lateral and/or rotational movement (e.g., yaw rotational movement) of the control panel assemblies in directions that are perpendicular with respect to the directions in which the control panel assemblies move into and out of the printing devices. As a result, the movable control panel assemblies disclosed herein may have relatively sturdy and high quality connections to the printing devices, even when the control panel assemblies are in fully extended positions.

As discussed herein, the control panel assemblies may include a base plate and a control panel support device. The control panel support device may be in a sliding or gliding arrangement with respect to the base plate. The base plate may be installed inside of a bay of a printing device and the control panel support device may slide or glide over the base plate. The control panel support device may move between a stowed position and an extended position. In the stowed position, a majority of the control panel support device may be housed within the bay of the printing device. In the extended position, a control panel and a control panel mount on which the control panel is mounted may fully extend out of the bay of the printing device. In some examples, a portion of the control panel may be visible while the control panel assembly is in the stowed position. In some examples, the control panel support device may also be positioned somewhere between the stowed position and the extended position.

The base plate may include a rib that extends from the base plate toward the control panel support device. The control panel support device may include a groove into which the rib is to be inserted when the control panel support device is in sliding arrangement with the base plate. The groove may include a first section having a first width and a second section having a second width. The second width may be smaller than the first width and may have approximately the same width as the rib. As a result, while the rib is in the first section, the control panel support device may move relatively freely in a first direction, e.g., the direction in which the control panel support device may be moved into and out of the printing device. However, while the rib is in second section, the rib may contact a side wall of the groove and may thus restrict movement of the control panel support device. Particularly, for instance, the contact between the rib and the side wall of the groove may reduce or prevent the control panel support device from rotating or moving laterally in a direction orthogonal (or perpendicular) to the first direction.

In some examples, the rib may be provided near a front section of the base plate. The front section of the base plate may be a section of the base plate that is nearest to an opening in a chassis through which the control panel support device is inserted into the printing device. In addition, the second section of the groove may be provided near a rear section of the control panel support device. The rear section of the control panel support device may be a section of the control panel support device that is opposite a control panel mount of the control panel support device. In some examples, the rib of the base plate and the second section of the control panel support device may be positioned such that the rib engages the second section when the control panel support device is in the fully extended position.

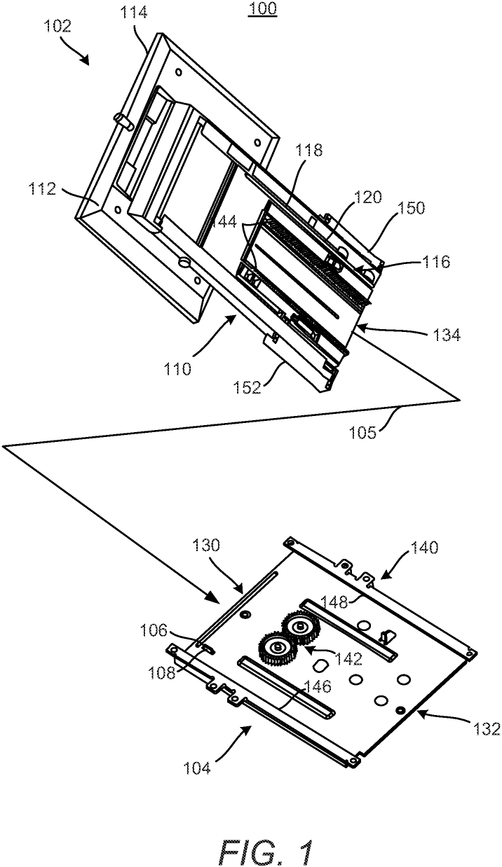

Reference is first made to FIG. 1, which shows a block diagram of an example control panel assembly 100 including features to reduce rotational movement of a control panel support device 102. It should be understood that the example control panel assembly 100 may include additional features and that some of the features described herein may be removed and/or modified without departing from the scope of the example control panel assembly 100.

As shown in FIG. 1, the control panel assembly 100, which may also be termed a movable control panel assembly 100, a control panel sub-assembly 100, a control panel system 100, or the like, may include a control panel support device 102 and a base plate 104. The control panel support device 102 is to be positioned to be in sliding arrangement with the base plate 104 as denoted by the arrow 105. In FIG. 1, the control panel support device 102 may be rotated such that the bottom surface of the control panel support device 102 faces the upper surface of the base plate 104. Following rotation of the control panel support device 102, the control panel support device 102 may be placed in the sliding arrangement with the base plate 104.

The base plate 104 may include a relatively flat surface and may be mounted to a chassis of a printing device through use of mechanical fasteners, tabs, friction fitting, adhesives, and/or the like. The base plate 104 may be formed of a metal and/or a plastic material and may include components for slidably engaging the control panel support device 102. As discussed herein, the components may engage other components on the control panel support device 102 such that the control panel support device 102 may move laterally with respect to the base plate 104. The base plate 104 may also include other features, such as features for increasing a stiffness of the base plate 104, holes for fasteners, and/or the like.

As also shown in FIG. 1, the control panel assembly 100 may include a rib 106 extending above the base plate 104. In some examples, the rib 106 may extend through an opening 108 in the base plate 104. In these examples, the rib 106 may be formed on a part of the chassis of the printing device upon which the base plate 104 is seated. In addition, the rib 106 may be formed of the same material as the chassis, e.g., a plastic material. In other examples, the rib 106 may be formed of the same material as the base plate 104, e.g., a plastic material, a metal, or the like.

In other examples, the rib 106 may be integrally formed with the base plate 104. In these examples, the rib 106 may be formed as a raised portion of the base plate 104. The rib 106 may alternatively be adhered and/or welded to the base plate 104. In any of these examples, the rib 106 may be positioned near a front section of the base plate 104.

As also shown in FIG. 1, the control panel support device 102 may include an elongated body 110 that may be positioned in sliding arrangement with the base plate 104. The control panel support device 102 may also include a control panel mount 112 upon which a control panel 114 may be mounted. In some examples, the control panel mount 112 may be rotatably mounted to the body 110 at a front section of the body 110. As discussed herein, the control panel mount 112 may be rotated between positions in which the control panel mount 112 is substantially parallel to the body 110 and in which the control panel mount 112 is at an angle with respect to the body 110. By way of example, the control panel mount 112 may be rotated between about 0° and about 45° from the horizontal axis. As another example, the control panel mount 112 may be rotated between about 0° and about 60° from the horizontal axis. In other examples, the control panel mount 112 may be rotated between other ranges of angles.

The control panel support device 102 may also include a groove 116 that extends in a lateral direction along the body 110. That is, the groove 116 may extend along a direction in which the control panel support device 102 is to move with respect to the base plate 104. The groove 116 may include a first section 118 and a second section 120. The first section 118 may have a first width and the second section 120 may have a second width, in which the second width is smaller than the first width. In addition, the first width may be larger than the width of the rib 106 while the second width may approximately be equal to the width of the rib 106.

According to examples, the first section 118 may have a length that is significantly longer than the length of the second section 120. The lengths of the first section 118 and the second section 120 may extend in the direction at which the control panel support device 102 is movable with respect to the base plate 104. Likewise, the widths of the first section 118 and the second section 120 may extend in a direction that is perpendicular to the direction at which the control panel support device 102 is movable with respect to the base plate 104. As shown in FIG. 1, the first section 118 of the groove 116 may extend along a relatively long distance along the control panel support device 102. In addition, the second section 120 of the groove 116 may extend a relatively short distance along the control panel support device 102.

As discussed herein, the rib 106 may be inserted into the groove 116 when the control panel support device 102 is in sliding arrangement with the base plate 104. For instance, the rib 106 may be inserted into the first section 118 while the control panel support device 102 is in a stowed position with respect to the base plate 104. The rib 106 may also be inserted in the first section 118 prior to the control panel support device 102 being moved to the fully extended position. While the control panel support device 102 is in the fully extended position, the rib 106 may be inserted in the second section 120.

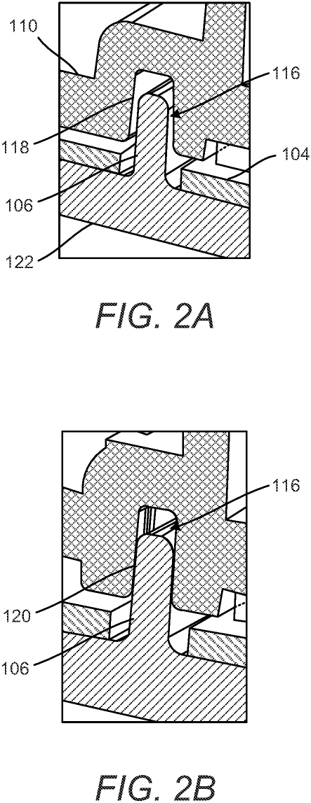

Reference is now made to FIG. 2A, which depicts an enlarged cross-sectional perspective view of a portion of the control panel assembly 100 depicted in FIG. 1 corresponding to the first section 118 of the groove 116. Particularly, FIG. 2A shows an example in which the rib 106 is integrally formed with a portion of the chassis 122 of a printing device. In addition, FIG. 2A shows the rib 106 inserted in the first section 118 of the groove 116. As shown, the rib 106 may have a width that is smaller than the width of the first section 118. As a result, the control panel support device 102 may be moved with respect to the base plate 104 without the rib 106 contacting the side walls of the groove 116 while the rib 106 is inserted in the first section 118.

Reference is now made to FIG. 2B, which depicts an enlarged cross-sectional perspective view of a portion of the control panel assembly 100 depicted in FIG. 1 corresponding to the second section 120 of the groove 116. FIG. 2A shows the rib 106 inserted in the second section 120 of the groove 116. As shown, the rib 106 may have a width that is approximately equivalent to the width of the second section 120. For instance, the width of the second section 120 of the groove 116 may be slightly larger than the width of the rib 106 such that the rib 106 may contact a sidewall or both sidewalls of the second section 120 when the rib 106 is positioned within the second section 120.

In other examples, a small gap may be provided between the rib 106 and one or both of the sidewalls of the second section 120. In these examples, the control panel support device 102 may slightly be moved or rotated with respect to the base plate 104 when the rib 106 is inserted in the second section 120. By way of particular example, the rib 106 may contact a sidewall or both sidewalls of the second section 120 when the rib 106 is control panel support device 102 is rotated anywhere between approximately 1° and approximately 5° with respect to a center line of the base plate 104.

With reference back to FIG. 1, the base plate 104 is depicted as including a front section 130 and a rear section 132. The control panel support device 102 is also depicted as having a rear section 134, which may be positioned over the rear section 132 of the base plate 104 when the control panel support device 102 is in a stowed position. The rear section 134 of the control panel support device 102 may be positioned closer to the front section 130 of the base plate 104 when the control panel support device 102 is in an extended position. As shown in FIG. 1, the rib 106 may be positioned in the front section 130 of the base plate 104. Particularly, the rib 106 may be positioned at a location in the front section 130 of the base plate 104 and the second section 120 may be positioned at a location near the rear section 134 of the control panel support device 102 such that the rib 106 is inserted in the second section 120 when the control panel support device 102 is in a fully extended position. In this regard, the rib 106 may be inserted into the first section 118 of the groove 116 when the control panel support device 102 is in the stowed position and prior to the control panel support device 102 reaching the fully extended position.

As the rib 106 may be in the wider first section 118 of the groove while the control panel support device 102 is not in the fully extended position, the rib 106 may not obstruct the lateral movement of the control panel support device 102 with respect to the base plate 104. In other words, the rib 106 may not impede or provide resistance against movement of the control panel support device 102 in a direction from the rear section 132 of the base plate 104 to the front section 130 of the base plate 104 while the rib 106 is inserted in the first section 118 of the groove 116. Likewise, the rib 106 may not impede movement of the control panel support device 102 in a direction from the front section 130 of the base plate 104 to the rear section 132 of the base plate while the rib 106 is inserted in the first section 118 of the groove 116.

However, when the control panel support device 102 is moved to the fully extended position, the rib 106 may be inserted in the second section 120 of the groove 116. As the rib 106 may contact one or both sidewalls of the second section 120, the rib 106 and the second section 120 may prevent or reduce rotational movement of the control panel support device 102 with respect to the base plate 104 when the control panel support device 102 is extended away from the base plate 104, e.g., when the control panel support device 102 is in the fully extended position.

According to examples, the base plate may include a guiding mechanism 140 that may guide the control panel support device 102 during movement of the control panel support device 102 with respect to the base plate 104. As shown in FIG. 1, the guiding mechanism 140 may include a pair of mesh gears 142 rotatably mounted to the base plate 104. For instance, a pair of posts may extend from an upper surface of the base plate 104 and the mesh gears 142 may be rotatably mounted on the posts. In some examples, the pair of mesh gears 142 may be positioned near a center of the base plate 104 near the front section 130 of the base plate 104.

As also shown in FIG. 1, the control panel support device 102 may include a pair of gear racks 144 that may extend in a lateral direction along a bottom surface of the control panel support device 102. In operation, the gears of the gear racks 144 may engage the gears of the mesh gears 142 when the control panel support device 102 is positioned in sliding arrangement with respect to the base plate 104. In this regard, the gears of the gear racks 144 may cause the mesh gears 142 to rotate as the control panel support device 102 is moved laterally with respect to the base plate 104. The mesh gears 142 and the gear racks 144 may cause the control panel support device 102 to move laterally and may provide a certain level of resistance against the lateral movement, which may provide a user with a higher quality feel during movement of the control panel support device 102.

In some examples, the guiding mechanism 140 may include a first slot 146 and a second slot 148 formed in the base plate 104. The first slot 146 and the second slot 148 may be formed to extend laterally between the front section 130 and the rear section 132 of the base plate 104. In addition, the first slot 146 and the second slot 148 may be formed along the side edges of the base plate 104. As shown in FIG. 1, the first slot 146 and the second slot 148 may be formed by bending parts of the base plate 104 into c-shaped channels.

In some examples, the control panel support device 102 may include a first glider 150 attached to a first side of the elongated body 110 of the control panel support device 102. The control panel support device 102 may also include a second glider 152 attached to a second side of the elongated body 110. In some examples, the first glider 150 may be inserted in the first slot 146 and the second glider 152 may be inserted in the second slot 148 when the control panel support device 102 is in sliding arrangement with the base plate 104. The engagement between the first glider 150 and the first slot 146 and the second glider 152 and the second slot 148 may further seat the control panel support device 102 with the base plate 104 during movement of the control panel support device 102 with respect to the base plate 104. In addition, the first glider 150 and the second glider 152 may abut a stop wall when the control panel support device 102 is in the fully extended position such that the control panel support device 102 may be blocked from being moved beyond the fully extended position.

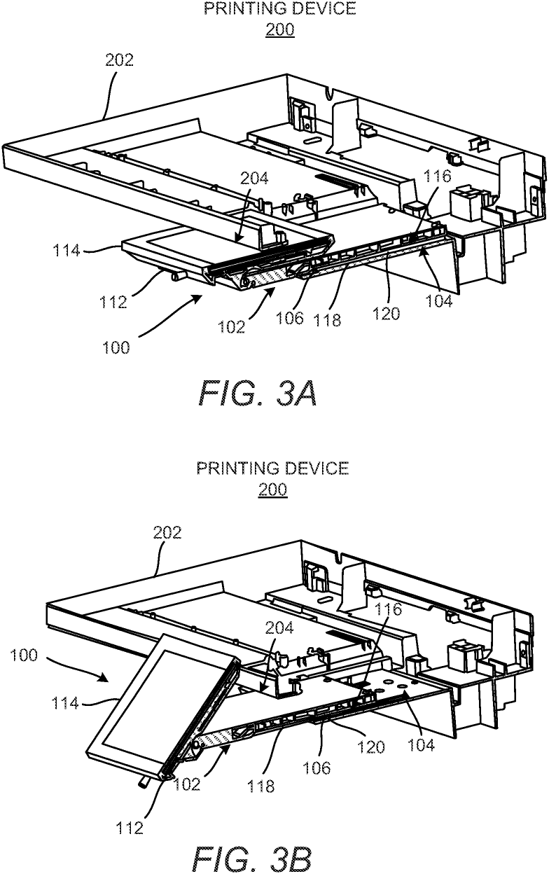

Reference is now made to FIGS. 3A and 3B, which respectively show portions of an example printing device 200, partially in cross-section, in which the example printing device 200 may include the control panel assembly 100 depicted in FIG. 1. FIGS. 3A and 3B show a portion of a chassis 202 of the printing device 200. The chassis 202 may house various picking mechanisms, motors, sensors, and/or the like to move sheets of media from a media tray to a print zone within the chassis 202. The print zone may include an area in which toner from a toner cartridge may selectively be applied onto the sheets of media, for instance, through use of laser beams, an imaging unit, a fuser unit, etc. Following printing of images onto the sheets of media, the sheets of media may be outputted to an output location, e.g., an output tray, of the printing device 200.

As shown in FIGS. 3A and 3B, the chassis 202 may include an opening 204 through which the control panel support device 102 of the control panel assembly 100 may be moved into and out of the chassis 202. Particularly, the chassis 202 may include a bay that may house the control panel assembly 100. The descriptions of FIGS. 3A and 3B are made with respect to the descriptions provided above with respect to FIGS. 1, 2A, and 2B.

FIG. 3A shows the control panel support device 102 in a stowed position such that a portion of the control panel 114 may be housed within the chassis 202. As shown, the control panel 114 may be in a folded or closed position with respect to the control panel support device 102 such that the control panel 114 may be inserted into the opening 204. In addition, FIG. 3A shows the control panel support device 102 in sliding arrangement with the base plate 104 such that the rib 106 is inserted in the first section 118 of the groove 116.

FIG. 3B shows the control panel support device 102 in a fully extended position. In addition, FIG. 3B shows that the control panel mount 112 is rotated such that the control panel 114 is at an angled position with respect to the body 110 of the control panel support device 102. As shown, the rib 106 may be inserted within the second section 120 of the groove 116 while the control panel support device 102 is in the fully extended position. As discussed herein, the rib 106 may engage the sidewalls of the second section 120, which may reduce or prevent rotational movement of the control panel support device 102 with respect to the chassis 202. In addition, the control panel support device 102 may relatively securely be held with respect to the chassis 202. This may also provide a user with a high quality look and feel when the control panel support device 102 is in the fully extended position.

Although described specifically throughout the entirety of the instant disclosure, representative examples of the present disclosure have utility over a \wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims -- and their equivalents -- in which all terms are meant in their broadest reasonable sense unless otherwise indicated.

What is claimed is:

1. A control panel assembly comprising:
a base plate;
a rib extending above the base plate; and
a control panel support device to be positioned in sliding arrangement with the base plate, the control panel support device including a groove having a first section and a second section, the first section having a first width and the second section having second width, wherein the second width is smaller than the first width, wherein the rib is inserted in the groove when the control panel support device is positioned in sliding arrangement with the base plate, wherein the rib is to engage the second section of the groove when the control panel support device is extended away from the base plate, and wherein the engagement between the rib and the second section of the groove is to reduce rotational movement between the control panel support device and the base plate.

2. The control panel assembly of claim 1, wherein a gap exists between the rib and the first section of the groove to prevent contact between the rib and the first section of the groove during sliding movement of the control panel support device and the base plate while the rib is inserted into the first section of the groove to enable the control panel support device to slide relatively smoothly on the base plate.

3. The control panel assembly of claim 1, wherein the base plate has a rear section and a front section, wherein the control panel support device is to slide in a direction toward the rear section to be moved into a stowed position and to slide in a direction toward the front section to be moved into an extended position.

4. The control panel assembly of claim 3, wherein the rib is positioned in the front section of the base plate and the second section of the groove is positioned near a rear of the control panel support device.

5. The control panel assembly of claim 1, further comprising:
a control panel mount rotatably connected to the control panel support device, wherein the rib is to engage the second section when the control panel mount is in a fully extended position.

6. The control panel assembly of claim 1, further comprising:
a pair of mesh gears rotatably mounted to the base plate; and
a pair of gear racks provided on the control panel support device, wherein each gear rack of the pair of gear racks engages a respective mesh gear of the pair of mesh gears when the control panel support device is positioned in sliding arrangement with the base plate.

7. The control panel assembly of claim 1, further comprising:
a first slot formed in the base plate;
a second slot formed in the base plate;
a first glider attached to the control panel support device; and
a second glider attached to the control panel support device, wherein the first glider is inserted in the first slot and the second glider is inserted in the second slot when the control panel support device is positioned in sliding arrangement with the base plate.

8. A printing device comprising:
a chassis including a bay into which a control panel assembly is to be movably inserted;
a base plate mounted to the chassis within the bay, the base plate including:
a guiding mechanism; and
a rib extending above the base plate; and
a control panel support device positioned in sliding arrangement with the base plate, the control panel support device including:
an engaging mechanism to engage the guiding mechanism; and
a groove having a first section having a first width and a second section having a second width, wherein the rib extending from the base plate is inserted within the groove, wherein the second width is smaller than the first width, and wherein the second width is approximately equal to a width of the rib.

9. The printing device of claim 8, wherein the first width of the first section is larger than the width of the rib to enable the rib to move freely within the first section and the rib is to contact side walls of the groove at the second section to reduce rotational movement between the control panel support device and the base plate.

10. The printing device of claim 8, wherein the base plate has a rear section and a front section, wherein the control panel support device is to slide in a direction toward the rear section to be moved into a stowed position and to slide in a direction toward the front section to be moved into an extended position, and wherein the rib is positioned in the front section of the base plate and the second section of the groove is positioned near a rear of the control panel support device.

11. The printing device of claim 8, further comprising:
a control panel mount rotatably connected to the control panel support device; and
a control panel mounted to the control panel mount.

12. The printing device of claim 8, wherein:
the guiding mechanism comprises a pair of mesh gears rotatably mounted to the base plate; and
the control panel support device comprises a pair of gear racks provided on the control panel support device, wherein each gear rack of the pair of gear racks engages a respective mesh gear of the pair of mesh gears.

13. The printing device of claim 8, further comprising:
a first slot formed in the base plate;
a second slot formed in the base plate;
a first glider attached to the control panel support device; and
a second glider attached to the control panel support device, wherein the first glider is inserted in the first slot and the second glider is inserted in the second slot when the control panel support device is positioned in sliding arrangement with the base plate.

14. A control panel system comprising:
a base plate having a front section and a rear section, the base plate comprising:
a guiding mechanism; and
a rib extending above the base plate, the rib being positioned near the front section of the base plate; and
a control panel support device comprising:
an engaging mechanism to engage the guiding mechanism, wherein the engaging mechanism and the guiding mechanism are to cause the control panel support device to move laterally with respect to the base plate; and
a groove having a first section and a second section, the first section having a first width and the second section having second width, wherein the second width is smaller than the first width, wherein the rib is inserted in the first section when the control panel support device is in a stowed position and the rib is inserted in the second section when the control panel support device is in an extended position.

15. The control panel system of claim 14, wherein the second width is approximately equal to a width of the rib.
